(19) United States
(12) Patent Application Publication
(10) Pub. No.: US 2019/0272346 A1
(43) Pub. Date: Sep. 5, 2019

(54) MULTI-MATERIAL OPTIMIZATION FOR 4D PRINTING OF ACTIVE ROD STRUCTURES

(71) Applicant: SINGAPORE UNIVERSITY OF TECHNOLOGY AND DESIGN, Singapore (SG)

(72) Inventors: Oliver Manuel WEEGER, Singapore (SG); Yue Sheng Benjamin KANG, Singapore (SG); Sai-Kit YEUNG, Singapore (SG); Martin Leonard DUNN, Singapore (SG)

(21) Appl. No.: 16/348,505

(22) PCT Filed: Nov. 10, 2017
(86) PCT No.: PCT/SG2017/050565

§ 371 Date: May 9, 2019

(30) Foreign Application Priority Data
Nov. 10, 2016 (SG) 10201609437S

(51) Int. Cl. G06F 17/50; B33Y 50/02; B29C 64/393

(52) U.S. Cl. CPC G06F 17/50; B33Y 50/02; G06F 2217/12; G06F 17/5009; B29C 64/393

(57) ABSTRACT

A design optimization and manufacturing approach for the creation of complex 3D curved rod structures with spatially variable material distributions that exhibit active deformation behavior is provided. The framework optimizes the cross-sectional properties of a rod structure, in particular the Young's modulus, such that under given loading conditions the rod structure may obtain one or more target shapes resulting from geometrically nonlinear deformation, from which the structure can then actively deform back to the original shape due to the shape memory effect. A novel algorithm is provided to generate physical realizations from the computational design model, which allows their direct fabrication via printing of shape memory composites with voxel-level compositional control with a multi-material 3D printer. The design and manufacture digital toolchain allows the continuous variation of multiple active materials as a route to optimize mechanical as well as active behavior of a structure.

### RELATED APPLICATIONS

The present application is a national stage entry according to 35 USC § 371 of PCT application No. PCT/SG2017/050565 filed on Nov. 10, 2017, which claims priority from Singapore application No. 102016094375 filed on Nov. 10, 2016, all of which are incorporated herein by reference in their entirety.

### TECHNICAL FIELD

Various aspects of this disclosure generally relate to digital design and manufacturing, and more particularly, to multi-material optimization for manufacturing active structures.

### BACKGROUND

Digital design and manufacturing is a rapidly growing field of research and application, as new ways to digitize design and manufacturing workflows are emerging and enabling products with new and/or optimized functionality, faster prototyping of virtual designs into physical artifacts, and direct production of parts. A particularly attractive paradigm is the ability to design and manufacture components based on the control of the composition of multiple materials at the scale of micrometer-size voxels in a 3-dimensional (3D) volume.

The creation of digital composite materials and components is also being enabled by simultaneous advances in active materials such shape memory polymers that can be switched between multiple equilibrium configurations by an environmental stimulus, e.g., a temperature change, without application of external forces. FIG. 1 is a diagram 100 illustrating an example of the shape memory process of a self-unfolding box. At 105, the initial or printed shape 130 is flat. The initially flat structure is heated to 60° C. inside a water bath to make it more compliant; then it can be easily deformed into the desired box shape 132, as illustrated at 110. At the end of the training phase, the box structure is cooled to room temperature and maintains its target shape 132 due to the shape memory effect (SME), as illustrated at 115. At 120, re-heating results in an active shape change behavior from the target box configuration 132 back to the flat initial shape 130.

When this controllable, nonlinear, active behavior is enabled by 3D printing of digital shape memory polymers (SMP) and composites (SMC), it is called 4-dimensional (4D) printing. These new possibilities in manufacturing and functionality call for the development of computational design methods and software, that allow designers, engineers and architects to virtually explore and optimize their drafts with respect to various kinds of design variables, such as shape, material and functionality, and then immediately physically realize them through 3D printing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One aspect of the disclosure provides a design optimization and manufacturing approach for the creation of complex 3D curved rod structures with spatially variable material distributions that exhibit active deformation behavior, enabled by the shape memory effect of 3D printed photopolymers—so-called 4D printing. The framework of some embodiments optimizes the cross-sectional properties of a rod structure, in particular the Young's modulus, such that under given loading conditions the rod structure may obtain one or more target shapes resulting from geometrically nonlinear deformation, from which the structure can then actively deform back to the original shape due to the shape memory effect. Some embodiments include a novel algorithm to generate physical realizations from the computational design model, which allows their direct fabrication via printing of shape memory composites with voxel-level compositional control with a multi-material 3D printer. The design and manufacture digital toolchain of some embodiments allows the continuous variation of multiple active materials as a route to optimize mechanical as well as active behavior of a structure, without changing the original shape of the 3D rod structure, which is not possible with a single material. The disclosure demonstrates the entire design-fabrication-test approach and illustrates its capabilities with examples including 3D characters, personalized medical applications, and complex structures that exhibit instabilities during their nonlinear deformation.

In an aspect of the disclosure, a method, a computer-readable medium, and an apparatus for digital design and manufacturing are provided. The apparatus may receive a rod structure with an original shape for fabrication. The apparatus may receive a target shape of the rod structure into which the original shape is to be deformed during a training phase. The apparatus may determine a material distribution for the fabrication of the rod structure in the original shape. The material distribution may enable the deformation of the original shape into the target shape during the training phase. The apparatus may fabricate the original shape of the rod structure based on the material distribution.

In some embodiments, to fabricate the original shape of the rod structure based on the material distribution, the apparatus may voxelize the original shape of the rod structure to obtain a voxel grid. The apparatus may further determine a material for each voxel of the voxel grid based on the material distribution, and fabricate the original shape of the rod structure based on the material determined for each voxel of the voxel grid.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of the shape memory process of a self-unfolding box.

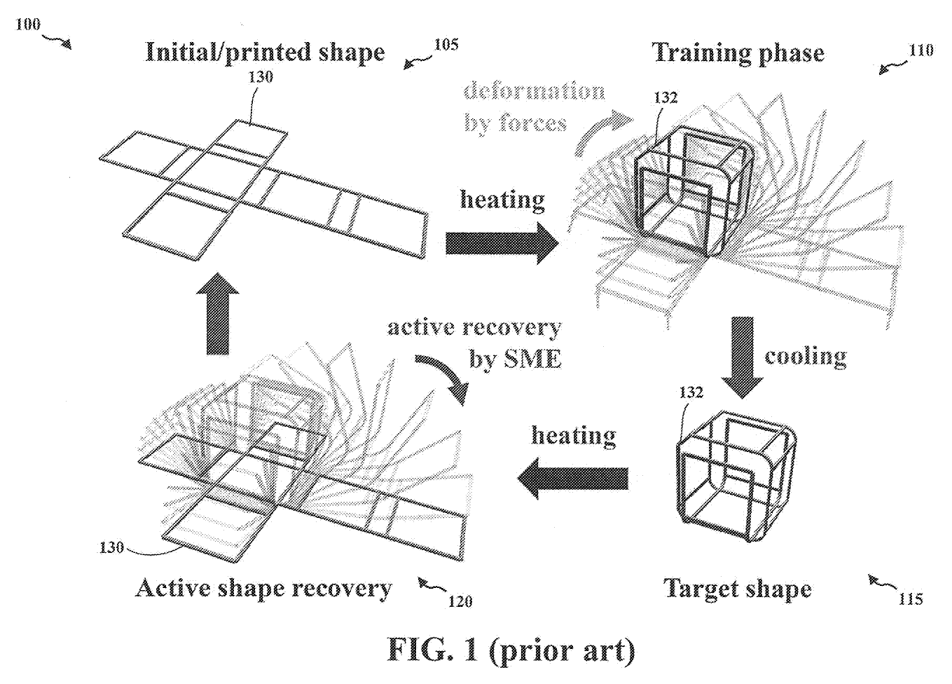

FIG. 2 is a diagram illustrating an example of the overall design-manufacturing process to create 3D rod structures with desired active shape change behavior.

FIG. 3 is a diagram illustrating an example of the optimization process for the case of an actuated Armadillo character.

FIG. 4 is a diagram illustrating an example of the outline of the multi-material 3D printing pipeline for Armadillo use case.

FIG. 5 illustrates a comparison of initial uniform and optimized material distributions and training behavior of box for computational and actual 3D printed models.

FIG. 6 illustrates a comparison of training behavior of computational and actual 3D printed Armadillo with initial uniform and optimized material distributions.

FIG. 7 illustrates a comparison of initial uniform and optimized material distributions and training behavior of T-Rex for two target shapes.

FIG. 8 illustrates a medical cast for the lower arm is optimized such that it can be manually flattened into its target configuration.

FIG. 9 is a flowchart of a method of digital design and manufacturing.

FIG. 10 is a flowchart of a method of digital manufacturing.

FIG. 11 is a conceptual data flow diagram illustrating the data flow between different means/components in an exemplary apparatus.

FIG. 12 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of digital design and manufacturing will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media may include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

One aspect of the disclosure presents a digital process flow from design optimization to graded multi-material manufacturing of active structures that use shape memory polymer composites to switch between multiple equilibrium configurations. Some embodiments of the disclosure focus on complex structures made from 3D curved rods since these structures can be made to be highly deformable and are thus well suited for large active nonlinear deformation behavior. Rod structures are versatile, and thus the approach of some embodiments may contribute to the creation of active lattice structures or scaffolds for surfaces and solids.

The main objective of some embodiments is to allow a designer to define initial (e.g., as printed) and target (e.g., trained) poses of a 3D rod structure, which specify two configurations that the structure can be switched between when heated. Given these shapes and corresponding loading conditions, some embodiments may formulate and solve a nonlinear optimization problem that determines the spatially varying material distribution of the Young's modulus, such that the error between the actual deformation and the target configuration is minimized. Some embodiments may employ algorithms to realize these objects by 3D printing with multi-material composition variations at the voxel scale. Though shape memory polymer composites are used in some embodiments to 3D print the physical realizations, the design framework of these embodiments is more general and could be easily applied to other active materials as well.

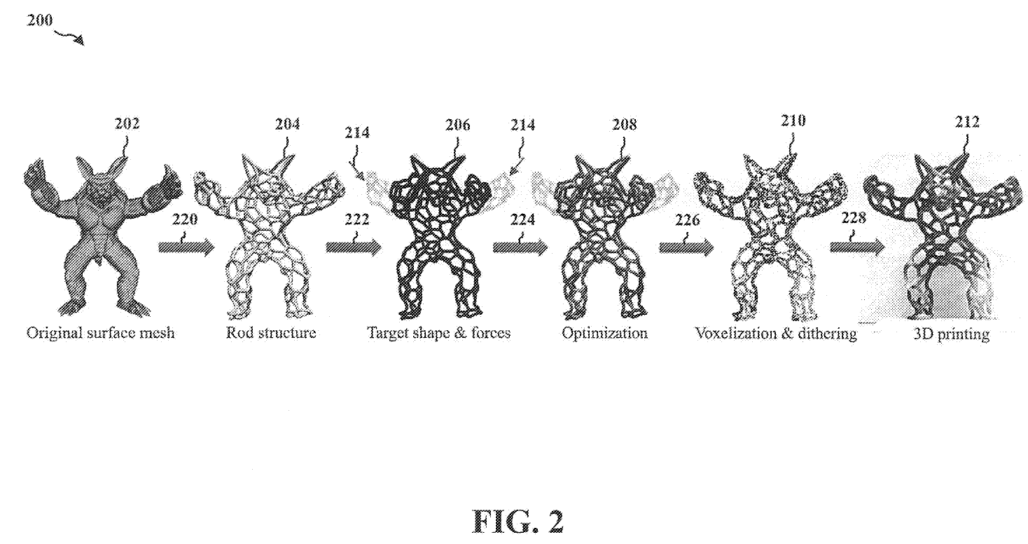

FIG. 2 is a diagram 200 illustrating an example of the overall design-manufacturing process to create 3D rod structures with desired active shape change behavior. In the example, the outline of the overall design-manufacturing pipeline is based on the Armadillo use case.

At 204, a surface mesh 202 of the Armadillo is converted into a rod structure 204. Modeling rod structures and simulating their mechanical deformation behavior may be essential capabilities that form the foundation of the design optimization approach of some embodiments. In some embodiments, the mechanics of 3-dimensional rods and rod structures may be described by the Cosserat rod model. An isogeometric method may be used for the numerical discretization and simulation of the rods. The isogeometric method may allow a direct integration of the framework into computer-aided design (CAD) environments.

At 222, loading conditions 214 and a target shape 206 are defined. Here, activeness is realized via 4D printing shape memory polymers and composite material designs that allow the rod structure 204 to actively deform back from the target shape 206 to the original printed shape when subject to an external stimulus such as heating.

The goal is to optimize for a spatially varying material composition of the rods such that it is possible to deform the rod structure 204 into the target shape 206 during the training phase by a simple set of forces. At 224, a nonlinear optimization problem may be formulated for the material distribution in terms of Young's moduli, where the objective is to minimize the deviation of the deformed shape 208 from the target shape 206, which is constrained by the mechanics of the rod structure 204. Optimization of the material distribution enables the designer to create an initial design, which does not change its visual appearance during the optimization process, as opposed to traditional shape and topology optimization approaches.

The realization of the optimized designs by a multi-material 3D printer may require a multi-material printing pipeline for material distributions with spatially variable stiffness. At 226, some embodiments may voxelize the optimized rod structure and then translate the continuous Young's modulus distributions into material ratios by a modulus-to-material mapping. Since each voxel can only contain one drop of a unique model material, dithering may need to be applied (at 226) to generate the model material distributions, which are then output as bitmaps files 210 for each layer of material and transferred to the printer.

After printing (at 228) and removing the support material, the printed-out rod structure 212 may be trained by heating and applying the design loads 214, cooling back to room temperature while maintaining the deformed configuration, and then removing the loads. Then the printed-out rod structure 212 may be tested to verify its active shape change behavior.

Exploitation of the shape memory effect may require the following process: a) fabricating a component from a suitable SMP so that it assumes its primary shape at room temperature; b) programming the component by heating it above its transition temperature, applying prescribed mechanical loads to deform it into a desired secondary shape, and then cooling it to room temperature while maintaining the loads or the shape, at which point it temporarily resides in its secondary shape; and c) deploying the component to actively recover its primary shape by heating it above its transition temperature. The performance of an SMP material and/or component is described by two parameters: a) fixity is the degree to which the deformed shape is retained after cooling and release of loads; and b) recovery is the degree to which the actual primary shape is recovered during deployment.

In some embodiments, a design and manufacturing workflow is developed for components constructed by rod meshes that can transform between a printed primary shape and a target secondary shape. The shape memory behavior of the rod structure may be enabled by fabricating them with shape memory composites (SMCs) that exhibit tunable shape memory behavior that can vary along the axis of each rod. These spatially dependent layouts may be realized by the voxel-level control of mixtures of two polymers as determined by optimal design of SMCs with microstructures at a scale an order of magnitude smaller than the rods themselves based on a rigid polymer and an elastomer. In order to simplify the design problem, some embodiments may ignore the time-dependence of the fixity and recovery processes of the composites in the rod structure and assume that they are perfect, i.e. 100%. This may reduce the design problem to determining the spatial distribution of the nonlinear elasticity (realized by an underlying composite microstructure) within a rod mesh at the elevated training temperature. This is significant because, even through the simplified computational design problem, some embodiments still exploit the sophisticated shape memory properties of fixity and recovery.

A rod is a slender, i.e. long and thin, 3-dimensional deformable body—its length being significantly longer than its cross-section diameter. For the mechanical modeling of relatively thick elastic rods, some embodiments use the nonlinear Cosserat rod theory. It is based on the description of the configuration of the rod as a framed curve. That is, a rod is represented by the line of its mass centroids, its centerline, which is a spatial curve r(s): [0,L]→ [symbol] ³ and a frame or triad R(s): [0,L]→SO(3), which describes the evolution of the orientation of the cross-sections along the centerline and can be associated with a rotation matrix R(s)=(d₁(s), d₂(s), d₃(s))∈ [symbol] ^{3×3}:R^{T}R=I.

This representation of a rod using its centerline curve and frames completely determines its kinematic configuration, which is governed by the equilibrium equations of linear and angular momentum, n′+\hat{n}=0 and m′+r′×n+\hat{m}=0, as well as boundary conditions. Here, n=Rσ and m=Rχ represent the internal forces and moments of the rod. External forces and moments are given by \hat{n} and \hat{m}. The stresses σ=CE and χ=Dκ are determined through linear constitutive laws using the strains ε=R^{T}r′−e₃ and κ=└R′^{T}R┘ₓ. The geometric and material properties of the rod cross-sections enter the formulation through the constitutive matrices C and D, which both depend on the Young's modulus E.

For the computational solution of the governing equations of the Cosserat rod model, some embodiments use an isogeometric collocation method. It provides an accurate and efficient numerical discretization of the model and enables a seamless integration of the design-to-manufacturing pipeline through a consistent representation of geometry using non-uniform rational basis spline (NURBS) curves: r(s)=Σᵢ₌₁ⁿNᵢ(s) rᵢ. Here Nᵢ are the n NURBS basis functions and rᵢ the control points of the curve. The rotation matrices are parameterized as R(s)≡R(q(s)) with unit quaternions q(s)=Σᵢ₌₁ⁿNᵢ(s) qᵢ, ∥q(s)∥=1.

Within the isogeometric collocation framework, these NURBS discretizations of centerline and rotation quaternions are substituted into the governing equations of the rod model and evaluated at n so-called collocation points. This determines a nonlinear system of equations f(\vec{r},\hat{q})=0 for the unknown vectors \vec{r}=(rᵢ)_{i=1, . . . , n} and \vec{q}=(qᵢ)_{i=1, . . . , n}, which has to be solved with a Newton's method in order to compute the deformed configuration of a rod. For the extension from a single rod to rod structures, i.e. meshes of interconnected rods, a rigid coupling of the rods may be enforced.

The initial geometry of a rod structure serves as input for the overall framework of some embodiments. Three different approaches may be supported. The first approach is a NURBS curve mesh import from CAD. The NURBS parameterization of the rods allows an isogeometric integration of the design and analysis process, without any format conversions or loss of geometric accuracy. Thus, designers or design engineers may manually draw or use procedural modeling approaches to generate NURBS curve meshes in a CAD software, which can then be directly imported into the design optimization framework of some embodiments.

The second approach is boundary extraction of NURBS surfaces. Very often in industrial computer-aided design and manufacturing, objects are designed by a boundary representation using a collection of many NURBS surfaces patches. A convenient way for rod mesh generation is thus the extraction of the boundary edges of these surfaces patches, which directly provides a collection of NURBS curves. With some more pre-processing, such as removal of duplicated curves, detection of intersections and insertion of additional isocurves, these curve meshes can also directly serve as rod meshes.

The third approach is from triangular surface meshes. Since triangle meshes are a frequent way of storing and exchanging 3D models in CAD and digital manufacturing, a mesh generation pipeline may be implemented for triangle meshes. First, the original high-resolution mesh is simplified until 100-500 triangles are left using the quadric error metric method, to which a check may be added for maintaining a manifold mesh during simplification to prevent mesh discontinuities at low triangle counts. Then the dual of the simplified mesh is constructed, mainly consisting of hexagonal shapes, which gives more freedom for deformation. These dual lines are then subdivided, projected back onto the original mesh and interpolated by NURBS curves.

The ultimate goal of the disclosure is to optimize the cross-sectional properties of the rods—in particular the material distribution within a rod structure—such that a desired target configuration (rₜ, Rₜ) can be achieved as deformation of an initial configuration (r₀, R₀) during the shape memory training phase. Therefore, the disclosure first introduces a parameterization of the design variables—the material parameters of the cross-section—and then derives a suitable optimization formulation.

The essential information about the material is featured in the constitutive matrices C and D of the Cosserat rod model, which depend on the Young's modulus E. Typically, E is overall constant for a rod, or even a whole structure, but here E is taken to be a design variable that can continuously vary with position and optimize its spatial dependence. Therefore, some embodiments may parameterize the design variable along the centerline of the rods, i.e. E≡E(s) for s∈[0,L]. Like r(s) and q(s), some embodiments discretize it according to the isogeometric concept as a NURBS curve: E(s)=Σᵢ₌₁ⁿ^{^{e}}Nᵢ^{e}(s)Eᵢ. Here some embodiments use n^{e} basis functions Nᵢ^{e}(s), which may not necessarily be the same as Nᵢ(s)'s above.

Some embodiments formulate a constrained nonlinear optimization problem for optimizing the Young's modulus distribution E(s) such that the deformed configuration (r, R) under given boundary conditions and design loads matches the shape of the desired target configuration (rₜ, Rₜ), which is specified by the designer, as close as possible:

$${min}_{{E}_{0} \leq \vec{E} \leq {E}_{1}} g ( \vec{E} ) s . t . f ( \vec{r} , \vec{q} ) = 0.$$

Here \vec{E}=(Eᵢ)_{i=1, . . . , n}_{^{e}} is the vector of design variables and E₀ and E₁ are the minimal and maximal Young's modulus values. The objective function g(\vec{E}) measures the deviation of the deformed rod configuration from the target configuration in terms of the errors of positions r(s) and curvatures K(s):

$$g ( \vec{E} ) = \frac{{C}_{r}}{2 {L}^{2}} {\sum }_{i = 1}^{n} {‖ r ( {τ}_{i} ) - {r}_{t} ( {τ}_{i} ) ‖}^{2} + \frac{{C}_{k} {L}^{2}}{2} {\sum }_{i = 1}^{n} {‖ κ ( {τ}_{i} ) - {κ}_{t} ( {τ}_{i} ) ‖}^{2}$$

For the overall rod structure, target function contributions from the individual rods defined are simply added to define the global objective function. This optimization problem is then solved using an iterative nonlinear optimization solver, which evaluates the constraint f(\vec{r},\vec{q}) and the design sensitivities dg/d\vec{E} in each iteration.

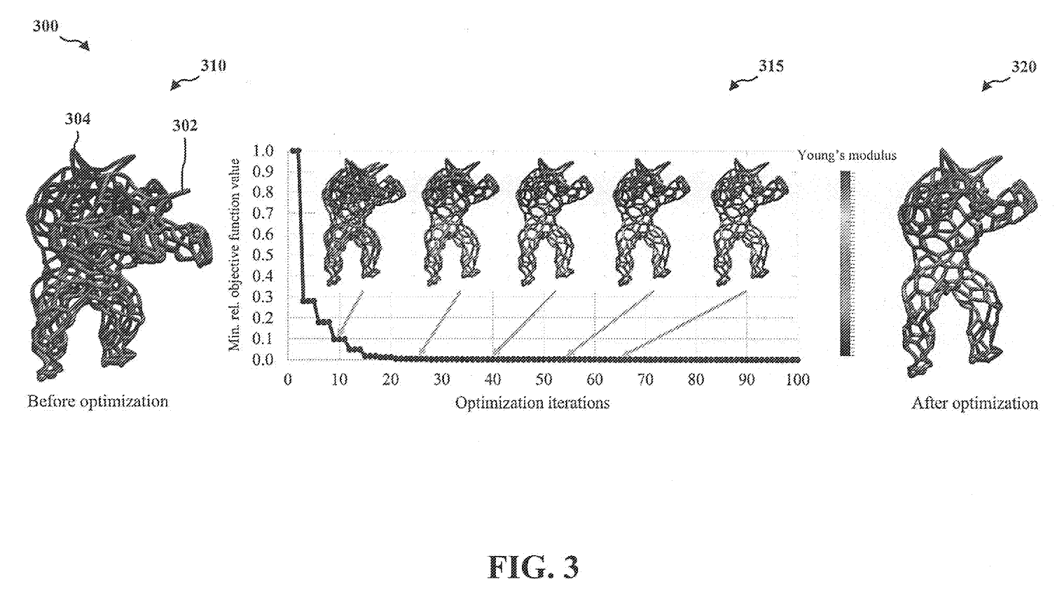

FIG. 3 is a diagram 300 illustrating an example of the optimization process for the case of an actuated Armadillo character. In the example, the deformed shape 302 is quite different from the target training shape 304 before optimization (at 310). During the optimization process (at 315), the deformed shape comes closer and closer to the target training shape. After 100 iterations, the relative objective function value g/go may be minimized from 1.0 to 6·10⁻⁵ and the optimized deformation and target shape have become indistinguishable (at 320).

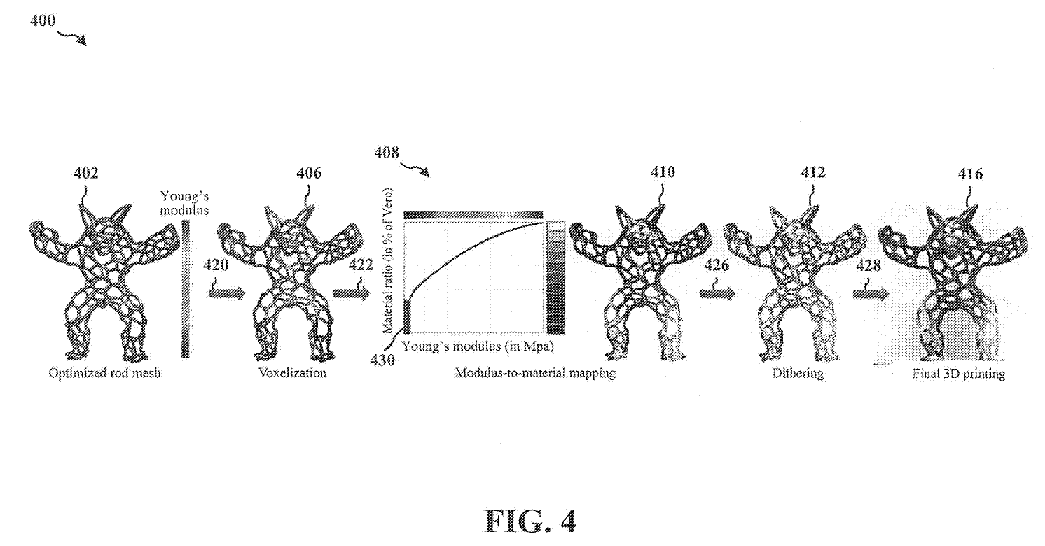

Once the optimal material distribution is obtained, some embodiments may realize it by 3D multi-material printing. FIG. 4 is a diagram 400 illustrating an example of the outline of the multi-material 3D printing pipeline for Armadillo use case. First, the rod mesh 402 with optimized Young's modulus distribution is converted (at 420) into a voxel grid 406. Then the Young's modulus values of each voxel are converted (at 422) to continuous material ratios 410 (e.g., a volume fraction of the model materials) using the modulus-to-material mapping 408. In the dithering step (at 426), a unique material is assigned to each voxel and the bitmaps 412 for final 3D printing using a multi-material printer capable of voxel-level control of material composition are generated. At 428, the multi-material printer produces a printed-out object 416.

Typically, solid bodies are represented as surfaces meshes, such as triangular meshes, and fast GPU-supported algorithms may be used for their voxelization. However, the volumetric representation of a rod mesh is given in terms of centerlines with cross-section frames and shapes. Furthermore, the volume fraction occupied by the rod mesh is in general much smaller than the full printing space, since rods are slender structures. The total number of voxels may be large (e.g., a 8.46×8.46×9.0 cm grid would contain 6 giga voxels). However, the rod mesh would only occupy a fraction of it. Thus, a voxelization method tailored to rod meshes is provided. For each individual rod, some embodiments iterate over its centerline r(s) in a suitable variable step size for s, which has to be smaller than one voxel. By evaluating the corresponding frame R(s), the representation of the cross-section may be obtained. Then, some embodiments may iterate through the current cross-section shape and assign the modulus E(s) to all voxels that are intersected by the cross-section plane. In this way, a sparse representation of the voxel grid of the rod structure may be obtained.

The next crucial step for printing the rod structures is to establish the relationship between the Young's modulus and actual material distributions, a modulus-to-material mapping. To this end, samples with random distributions of two model materials (here soft/rubbery Tango, and hard/stiff Vero) with volume fractions of the hard/stiff material ranging from 0% to 100% are created and their modulus are measured in a dynamic mechanical analysis (DMA) at 60° C., which is the temperature at which structures are deformed during training. From this data, an approximation function is generated to provide the required continuous material-modulus relationship (e.g., the modulus-to-material mapping 408) for use in the optimization.

Based on this material fraction, some embodiments may assign a unique model material to each voxel. In this dithering phase, some embodiments iterate over all layers of the voxel grid 406 and for each layer two binary sparse matrices (bitmaps) are initialized. For every voxel with non-zero stiffness, some embodiments use the above-mentioned relationship to determine the corresponding material volume ratio η(E)∈[0,1]. Then a random number ζ∈[0,1] is generated and based on it the bitmap values are assigned: If ζ<η the bitmap value for material 1 is set to 1, otherwise the bitmap value for material 2. The result of this random/white-noise dithering, or mezzo tinting procedure, are two stacks of bitmap files for each layer, one for each base material. Some embodiments use this random dithering approach here, since a high-frequency distribution without clustering gives the most adequate mixture of the two base materials.

Some embodiments print out the rod structures on a poly jet 3D printer that can print up to three different photopolymer materials simultaneously. Using its voxel-printing capability, some embodiments input models as stacks of bitmaps for each material and layer. In some embodiments, the materials from the Tango and Vero families (e.g., TangoBlackPlus and VeroWhitePlus) may be used. Tango materials are rubbery elastomers, i.e. have a low Young's modulus (˜2 MPa at 25° C., ˜0.5 MPa at 60° C.), while Vero materials are rigid polymers with a higher Young's modulus (˜2,000 MPa at 25° C., ˜190 MPa at 60° C.). Both materials generally exhibit the shape memory effect and have temperature-dependent material properties. However, the glass transition temperature of Tango is about 13° C., and the materials may be used over the range from room temperature to 60° C. so it behaves like an elastomer and does not exhibit shape memory behavior. To ensure sufficient fixity at 25° C. in the structures, some embodiments restrict the minimal Young's modulus in the optimization to 8 MPa, corresponding to a volume ratio of 30% Vero, as indicated by the box 430 in the modulus-to-material mapping 408.

The results and a number of applications of the multi-material optimization and 3D printing framework for active, shape changing rod structures are described below. For all cases, some embodiments may print optimized structures, train them by heating in a water bath at 60° C., applying the appropriate mechanical loads, and cooling to room temperature while maintaining the fixed displacements and removing the loads, and then reheating the structures in the water bath at 60° C. to demonstrate the shape change.

3D printing a flat structure is faster and more economical than printing a complex, truly 3-dimensional structure. Furthermore, it also makes storage and shipping of an object easier when it is flat and can self-assemble into another desired shape. In some embodiments, a flat structure may be designed. The flat structure may be folded into a box during the training phase and unfold back as shape recovery. For the training of this very large deformation and rotation behavior, forces may only be applied perpendicular to the outer edges of the structure, which does not result in the desired box shape with straight edges for the uniform material case.

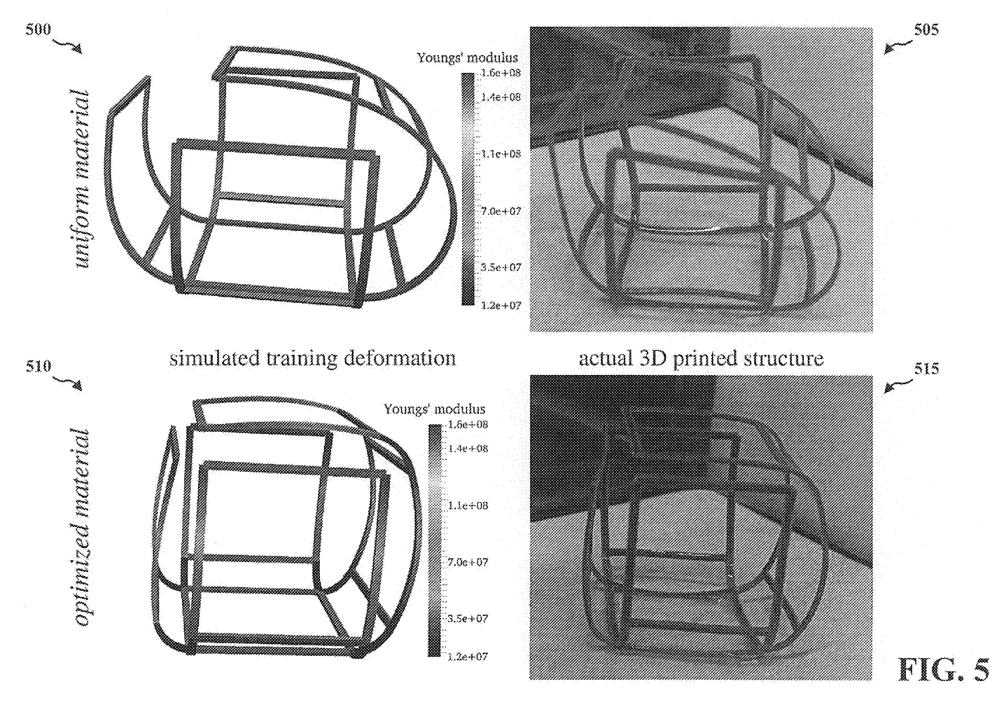

FIG. 5 illustrates a comparison of initial uniform and optimized material distributions and training behavior of box for computational and actual 3D printed models. The diagram 500 shows the simulated training deformation of a box with uniform material distribution. The diagram 505 shows the actual training deformation of a box printed out with uniform material distribution. The diagram 510 shows the simulated training deformation of a box with optimized material distribution. The diagram 515 shows the actual training deformation of a box printed out with optimized material distribution. As can be seen in the diagram 510, the optimized material distribution gives a much better result in folding into the desired box shape in simulation, which is again validated by the manual training of printed structures shown in the diagram 515.

The Stanford armadillo example is used in FIGS. 2-4 above. The original input mesh consists of 345,944 triangles and the dual of triangle mesh procedure may be used to generate a complex mesh with 391 curved rods. The goal is to apply a large deformation to this 3D character during the training phase such that its arms move to the front by inwards directed forces at a point on each hand, while the lower body and legs remain still. As it can be seen at 310 in FIG. 3, this is not the case for an un-optimized rod structure with uniform material distribution, but the multi-material optimization enables this desired target deformation.

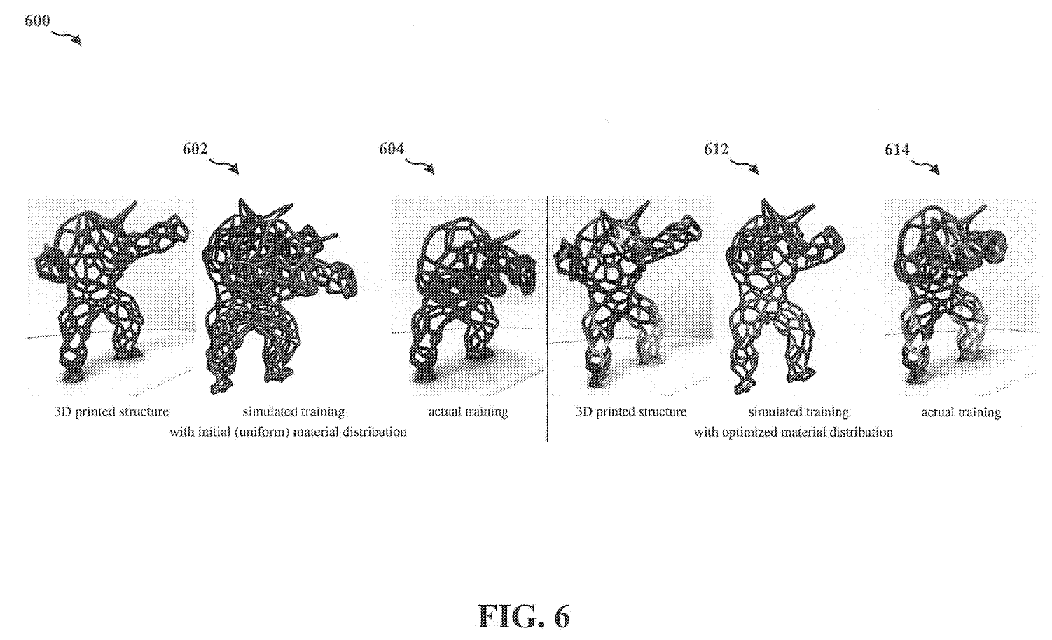

FIG. 6 illustrates a comparison of training behavior of computational and actual 3D printed Armadillo with initial uniform and optimized material distributions. While the uniform material version bends to the front during training (as shown in diagrams 602 and 604), the optimized one remains straight (as shown in diagrams 612 and 614). In addition, the actual 3D printed Armadillos (shown in the diagram 614) validates the computational result (shown in the diagram 612) very well.

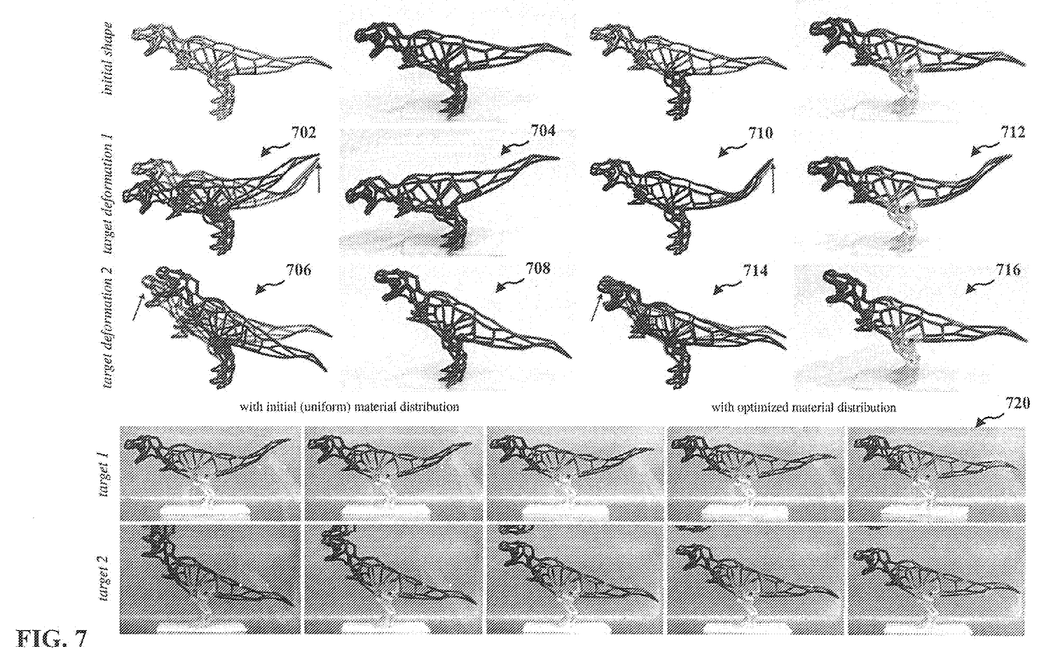

Another toy-like example with a complex geometry is the Tyrannosaurus rex (T-Rex). FIG. 7 illustrates a comparison of initial uniform and optimized material distributions and training behavior of T-Rex for two target shapes. In one embodiment, the mesh with 287 curved rods is generated from an original input mesh with 9,874 triangles. For the active shape recovery behavior, the T-Rex model may be trained with two target poses: the head moving up while the tail remains straight and vice versa. While this is not the case for the uniform material dinosaur, which just bends up and down straight (as shown in diagrams 702-708), the optimized version enables both the desired target deformations—though not perfectly (as shown in diagrams 710-716). The computational and actual deformations of the 3D printed models correspond very well. Snapshots of active shape deformation of optimized T-Rex from both trained target poses (left) to printed initial shape (right) inside a hot water bath are shown in the diagram 720.

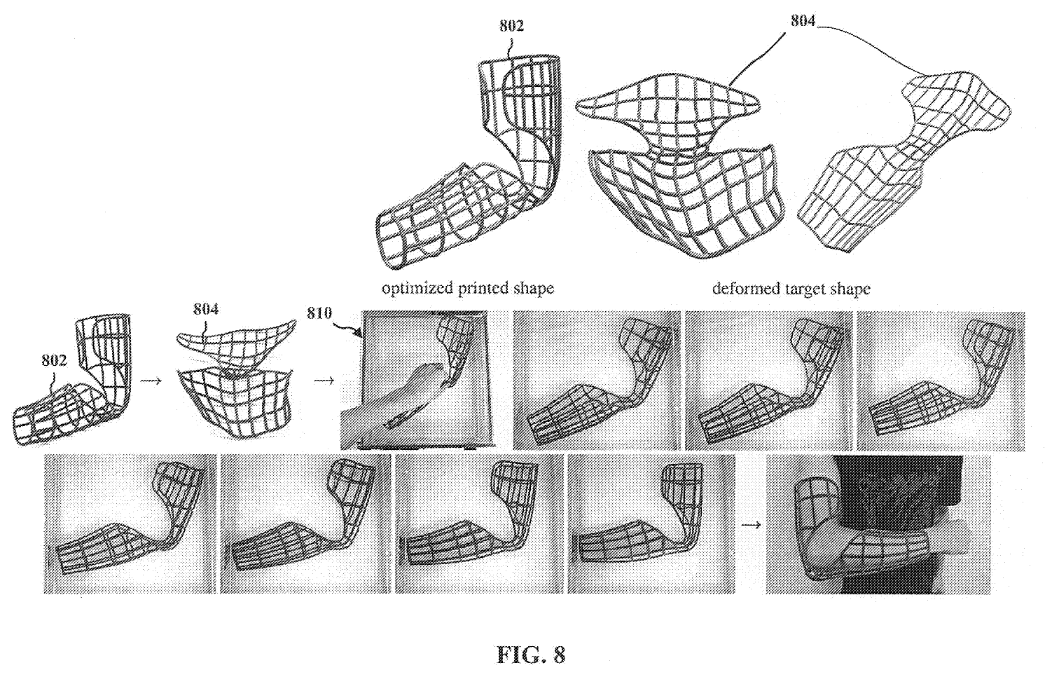

FIG. 8 illustrates a medical cast for the lower arm is optimized such that it can be manually flattened into its target configuration 804. The cast was designed in a CAD program based on the shape of a real arm—in practice it could be a patient-specific design—and printed in its permanent cast shape 802. The material distribution was then optimized such that it can be flattened by hand, which allows easier storage of the cast. More importantly, a paramedic can now simply heat up the cast so it recovers back to its original shape 802 and automatically fits around the arm of a patient. As shown by a series of snapshots 810, from the target configuration 804, the cast can actively deform back into the printed shape 802 and fix a patient's arm.

The disclosure provides a framework for the design and manufacture of 3D printed multi-material rod structures with active shape change behavior, so-called 4D printing. In some embodiments, the integral components of the method may include: the modeling and simulation of 3-dimensional rod structures; the formulation of a nonlinear optimization problem for assignment of spatially varying material distributions to match deformation of the rod structure during shape memory training phase with the target shape; and multi-material 3D printing stage to create realization of the rod structures with spatially varying, gradient elastic properties.

Even though hot and cold water baths are used to warm the rod structures for training deformation and cool them for shape storage, one of ordinary skill in the art would recognize that other methods such as using conductive heating by embedding electrical wires may be used in conjunction or instead. Furthermore, the active shape recovery behavior adopted in this work requires a training phase first. Considering other mechanical phenomena, such as thermal deformation and residual stresses, it could also possible to optimize the design of structures with a fully active behavior, which do not require training, can recover only gradually or even into different shapes.

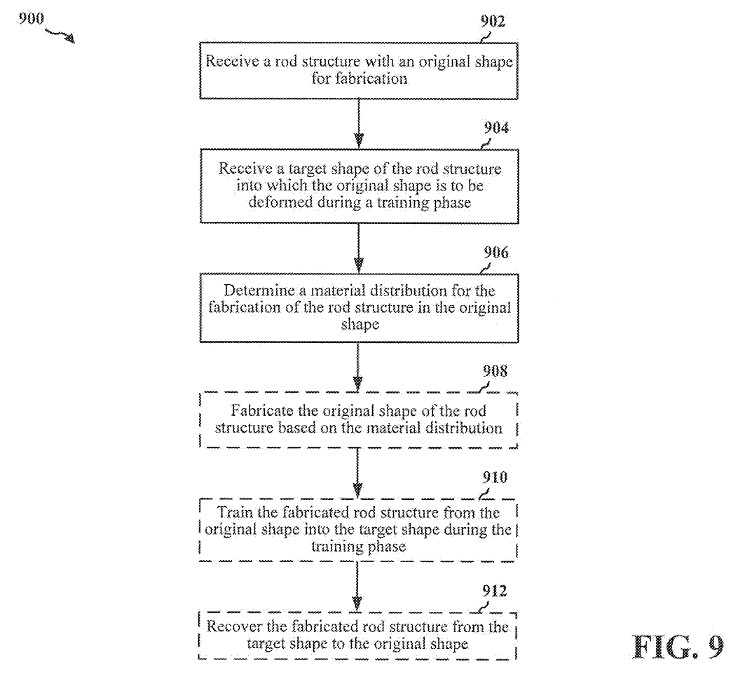

FIG. 9 is a flowchart 900 of a method of digital design and manufacturing. In one embodiment, the method may be performed by an apparatus (e.g., the apparatus 1102/1102′). In one embodiment, the apparatus may include a 3D printer.

At 902, the apparatus may receive a rod structure with an original shape for fabrication. At 904, the apparatus may receive a target shape of the rod structure into which the original shape is to be deformed during a training phase.

At 906, the apparatus may determine a material distribution for the fabrication of the rod structure in the original shape. The material distribution may enable the deformation of the original shape into the target shape during the training phase. In one embodiment, to determine the material distribution, the apparatus may formulate and resolve a nonlinear optimization problem for the material distribution. The objective of the nonlinear optimization problem is to minimize the deviation of the deformed shape from the target shape. In one embodiment, the material distribution may include Young's modulus distributions.

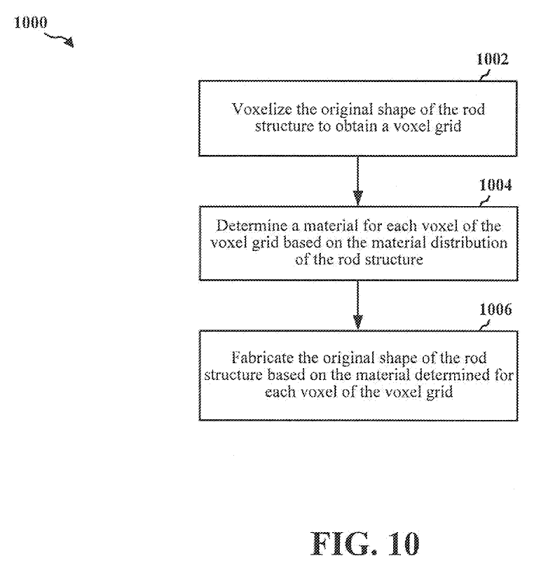

At 908, the apparatus may optionally fabricate the original shape of the rod structure based on the material distribution. In one embodiment, the fabrication may be performed by a 3D printer. Further details of the fabrication of the rod structure of some embodiments will be described below in FIG. 10.

At 910, the apparatus may optionally train the fabricated rod structure from the original shape into the target shape during the training phase. In one embodiment, to train the fabricated rod structure, the apparatus may apply a set of forces to the fabricated rod structure to deform the fabricated rod structure from the original shape into the target shape.

At 912, the apparatus may optionally recover the fabricated rod structure from the target shape to the original shape.

FIG. 10 is a flowchart 1000 of a method of digital manufacturing. In one embodiment, the method may be performed by an apparatus (e.g., the apparatus 1102/1102′). In one embodiment, the apparatus may include a 3D printer. In one embodiment, the operations performed in the method may include the operations performed at 908 in FIG. 9.

At 1002, the apparatus may voxelize the original shape of the rod structure to obtain a voxel grid.

At 1004, the apparatus may determine a material for each voxel of the voxel grid based on the material distribution of the rod structure. In one embodiment, to determine the material for each voxel, the apparatus may map a Young's modulus value corresponding to the voxel to a material ratio, and dither based on the material ratio to determine the material for the voxel.

At 1006, the apparatus may fabricate the original shape of the rod structure based on the material determined for each voxel of the voxel grid.

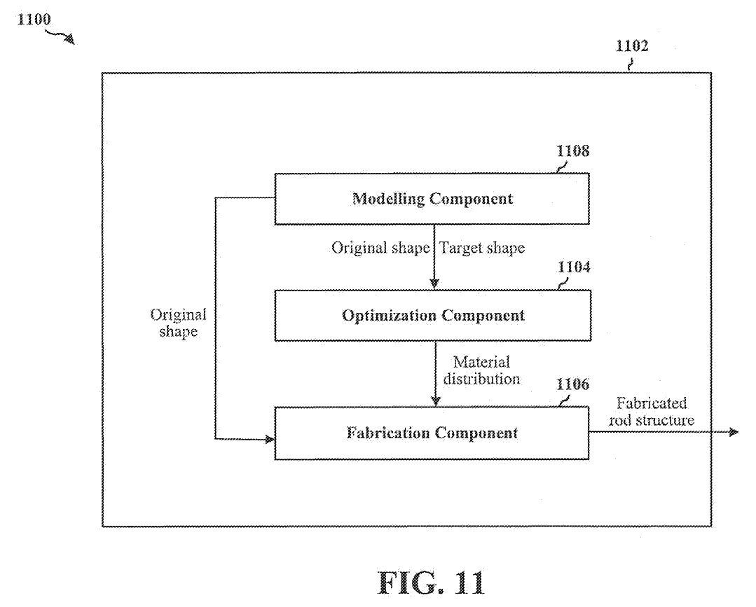

FIG. 11 is a conceptual data flow diagram 1100 illustrating the data flow between different means/components in an exemplary apparatus 1102. In one embodiment, the apparatus 1102 may include a 3D printer.

The apparatus 1102 may include a modeling component 1108 that models and simulates the behavior of an object. In one embodiment, the modeling component 1108 may generate the rod structures for the original shape and target shape of the object.

The apparatus 1102 may include an optimization component 1104 that optimizes the material distribution for the fabrication of the rod structure in the original shape. In one embodiment, the optimization component 1104 may perform the operations described above with reference to 906 in FIG. 9.

The apparatus 1102 may include a fabrication component 1106 that fabricates the original shape of the rod structure. In one embodiment, the fabrication component 1106 may perform the operations described above with reference to 908 in FIG. 9, or 1002, 1004, 1006 in FIG. 10.

The apparatus 1102 may include additional components that perform each of the blocks of the algorithm in the aforementioned flowcharts of FIGS. 9, 10. As such, each block in the aforementioned flowcharts of FIGS. 9, 10 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

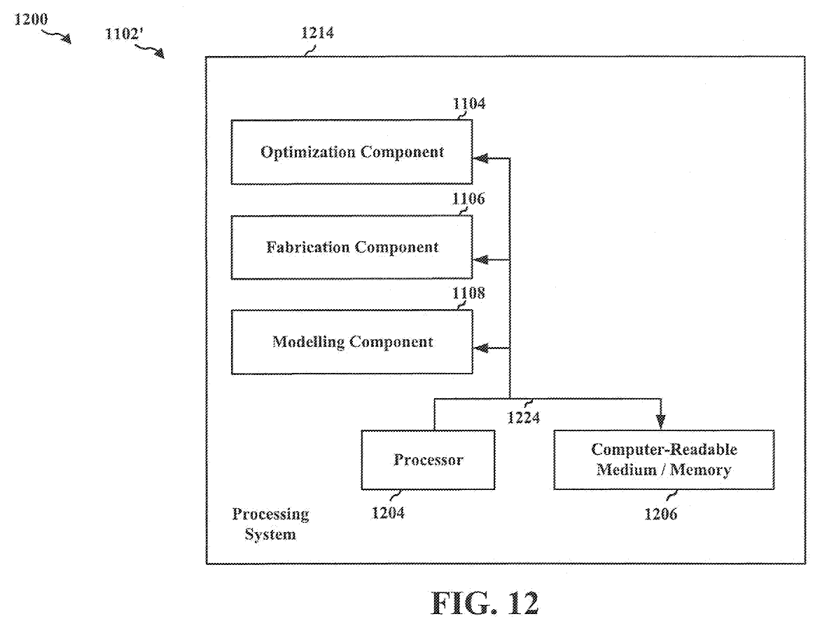

FIG. 12 is a diagram 1200 illustrating an example of a hardware implementation for an apparatus 1102′ employing a processing system 1214. In one embodiment, the apparatus 1102′ may be the apparatus 1102 described above with reference to FIG. 11. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware components, represented by the processor 1204, the components 1104, 1106, 1108, and the computer-readable medium/memory 1206. The bus 1224 may also link various other circuits such as timing sources, peripherals, voltage regulators, and power management circuits, which are well known in the art, and therefore, will not be described any further.

The processing system 1214 includes a processor 1204 coupled to a computer-readable medium/memory 1206. The processor 1204 is responsible for general processing, including the execution of software stored on the computer-readable medium/memory 1206. The software, when executed by the processor 1204, causes the processing system 1214 to perform the various functions described supra for any particular apparatus. The computer-readable medium/memory 1206 may also be used for storing data that is manipulated by the processor 1204 when executing software. The processing system 1214 further includes at least one of the components 1104, 1106, 1108. The components may be software components running in the processor 1204, resident/stored in the computer readable medium/memory 1206, one or more hardware components coupled to the processor 1204, or some combination thereof.

In the following, various aspects of this disclosure will be illustrated:

Example 1 is a method or apparatus for digital design and manufacturing. The apparatus may receive a rod structure with an original shape for fabrication, receive a target shape of the rod structure into which the original shape is to be deformed during a training phase, and determine a material distribution for the fabrication of the rod structure in the original shape. The material distribution may enable deformation of the original shape into the target shape during the training phase.

In Example 2, the subject matter of Example 1 may optionally include that the apparatus may further fabricate the original shape of the rod structure based on the material distribution.

In Example 3, the subject matter of Example 2 may optionally include that, to fabricate the original shape of the rod structure based on the material distribution, the apparatus may: voxelize the original shape of the rod structure to obtain a voxel grid; determine a material for each voxel of the voxel grid based on the material distribution; and fabricate the original shape of the rod structure based on the material determined for each voxel of the voxel grid.

In Example 4, the subject matter of Example 3 may optionally include that, to determine the material for each voxel, the apparatus may map a Young's modulus value corresponding to the voxel to a material ratio, and dither based on the material ratio to determine the material for the voxel.

In Example 5, the subject matter of any one of Examples 2 to 4 may optionally include that the apparatus may train the fabricated rod structure from the original shape into the target shape during the training phase.

In Example 6, the subject matter of Example 5 may optionally include that, to train the fabricated rod structure, the apparatus may apply a set of forces to the fabricated rod structure to deform the fabricated rod structure from the original shape into the target shape.

In Example 7, the subject matter of any one of Examples 5 to 6 may optionally include that the apparatus may further recover the fabricated rod structure from the target shape to the original shape.

In Example 8, the subject matter of any one of Examples 1 to 7 may optionally include that, to determine the material distribution, the apparatus may formulate and resolve a nonlinear optimization problem for the material distribution, where the objective of the nonlinear optimization problem is to minimize a deviation of the deformed shape from the target shape.

In Example 9, the subject matter of any one of Examples 1 to 8 may optionally include that the material distribution may include Young's modulus distributions.

A person skilled in the art will appreciate that the terminology used herein is for the purpose of describing various embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of digital design and manufacturing, the method comprising:
receiving a rod structure with an original shape for fabrication;
receiving a target shape of the rod structure into which the original shape is to be deformed during a training phase; and
determining a spatially varying Young's modulus distribution for the fabrication of the rod structure in the original shape, the spatially varying Young's modulus distribution enabling deformation of the original shape into the target shape during the training phase, wherein the determining of the spatially varying Young's modulus distribution comprises resolving a nonlinear optimization problem for the spatially varying Young's modulus distribution, wherein an objective of the nonlinear optimization problem is to minimize a deviation of a deformed shape from the target shape.

2. The method of claim 1, further comprising:
fabricating the original shape of the rod structure based on the spatially varying Young's modulus distribution.

3. The method of claim 2, wherein the fabricating of the original shape of the rod structure based on the spatially varying Young's modulus distribution comprises:
voxelizing the original shape of the rod structure to obtain a voxel grid;
determining a material for each voxel of the voxel grid based on the spatially varying Young's modulus distribution; and
fabricating the original shape of the rod structure based on the material determined for each voxel of the voxel grid.

4. The method of claim 3, wherein the determining of the material for each voxel comprises:
mapping a Young's modulus value of the spatially varying Young's modulus distribution corresponding to the voxel to a material ratio; and
dithering based on the material ratio to determine the material for the voxel.

5. The method of claim 2, further comprising:
training the fabricated rod structure from the original shape into the target shape during the training phase.

6. The method of claim 5, wherein the training of the fabricated rod structure comprises applying a set of forces to the fabricated rod structure to deform the fabricated rod structure from the original shape into the target shape.

7. The method of claim 5, further comprising:
recovering the fabricated rod structure from the target shape to the original shape.

8. (canceled)

9. (canceled)

10. An apparatus for digital design and manufacturing, the apparatus comprising:
a memory; and
at least one processor coupled to the memory and configured to:
receive a rod structure with an original shape for fabrication;
receive a target shape of the rod structure into which the original shape is to be deformed during a training phase; and
determine a spatially varying Young's modulus distribution for the fabrication of the rod structure in the original shape, the spatially varying Young's modulus distribution enabling deformation of the original shape into the target shape during the training phase,
wherein, to determine the spatially varying Young's modulus distribution, the at least one processor is configured to resolve a nonlinear optimization problem for the spatially varying Young's modulus distribution, wherein an objective of the nonlinear optimization problem is to minimize a deviation of a deformed shape from the target shape.

11. The apparatus of claim 10, wherein the at least one processor is further configured to:
fabricate the original shape of the rod structure based on the spatially varying Young's modulus distribution.

12. The apparatus of claim 11, wherein, to fabricate the original shape of the rod structure based on the spatially varying Young's modulus distribution, the at least one processor is configured to:
voxelize the original shape of the rod structure to obtain a voxel grid;
determine a material for each voxel of the voxel grid based on the spatially varying Young's modulus distribution; and
fabricate the original shape of the rod structure based on the material determined for each voxel of the voxel grid.

13. The apparatus of claim 12, wherein, to determine the material for each voxel, the at least one processor is configured to:
map a Young's modulus value of the spatially varying Young's modulus distribution corresponding to the voxel to a material ratio; and
dither based on the material ratio to determine the material for the voxel.

14. The apparatus of claim 11, wherein the at least one processor is further configured to:
train the fabricated rod structure from the original shape into the target shape during the training phase.

15. The apparatus of claim 14, wherein, to train the fabricated rod structure, the at least one processor is configured to apply a set of forces to the fabricated rod structure to deform the fabricated rod structure from the original shape into the target shape.

16. The apparatus of claim 14, wherein the at least one processor is further configured to:
recover the fabricated rod structure from the target shape to the original shape.

17. (canceled)

18. (canceled)

19. A computer-readable medium storing computer executable code, comprising instructions for:
receiving a rod structure with an original shape for fabrication;
receiving a target shape of the rod structure into which the original shape is to be deformed during a training phase; and
determining a spatially varying Young's modulus distribution for the fabrication of the rod structure in the original shape, the spatially varying Young's modulus distribution enabling deformation of the original shape into the target shape during the training phase, wherein the determining of the spatially varying Young's modulus distribution comprises resolving a nonlinear optimization problem for the spatially varying Young's modulus distribution, wherein an objective of the nonlinear optimization problem is to minimize a deviation of a deformed shape from the target shape.

20. The computer-readable medium of claim 19, further comprising instructions for:
fabricating the original shape of the rod structure based on the spatially varying Young's modulus distribution.
